(19) United States
(12) Patent Application Publication
(10) Pub. No.: US 2009/0144154 A1
(43) Pub. Date: Jun. 4, 2009

(54) Intelligent media targeting system and method

(75) Inventor: Steven Michael Schein, Huntington Beach, CA (US)

Correspondence Address: MARTIN & FERRARO, LLP, 1557 LAKE O'PINES STREET, NE, HARTVILLE, OH, 44632, US

(73) Assignee: Intertainer, Inc.

(21) Appl. No.: 12/322,743

(22) Filed: Feb. 7, 2009

Related U.S. Application Data
(63) Continuation of application No. 09/605,695, filed on Jun. 28, 2000.

(51) Int. Cl. G06Q 30/00; G06F 17/30

(52) U.S. Cl. 705/14; 707/104.1; 705/1; 707/E17.044

(57) ABSTRACT

An intelligent media targeting system and method for generating and utilizing smart media objects, or information objects containing both a content portion containing information to be consumed by end users and a profile portion containing coded user activity information representing exercise of the media object by users, the content portion and the profile portion being assembled into an information object capable of being transmitted integrally. The smart media objects are generated by capturing user activity information representing exercise of media objects by users, filtering the captured user activity information to generate a profile for each media object, generating a coded header using the profile for each media object and attaching the coded header to the media object. After the smart media objects are transmitted over a communication channel, the coded headers are detached and decoded to obtain the profile of the smart media objects. Media targeting decisions are then made to target media objects to end users based on the media object profile obtained by detaching and decoding the coded header.

This application is a continuation of U.S. application Ser. No. 09/605,695, filed Jun. 8, 2000; which is incorporated by reference herein.

### BACKGROUND OF THE INVENTION

1. Field of the Invention

The invention relates to targeting media content to users, and in particular, to a system and method for automatically targeting intelligent media content to users based on user activity information associated with such content.

2. Description of the Related Art

Traditional media targeting concerns operate to direct content to consumers by matching information about a consumer with information about particular content based on user inputs. In this context, the content generally includes advertisements, e-commerce promotions, and other information content deliverable through communication channels and ultimately consumed or exercised (e.g., purchased, viewed, interacted with) by users. For example, an Internet user surfing the World Wide Web for discount airplane fares to Hawaii may receive unsolicited advertisements about Hawaiian hotels. In this instance, the user is targeted to receive distinct content based on the user's searching inquiries.

Many media targeting methods focus on generating user profiles (i.e., demographic, psychographic, and/or other information associated with individual users or groups of users). In this regard, U.S. Pat. Nos. 5,790,426 and 5,918,014 to Robinson describe methods for determining a subject's community (i.e., people with similar likes and dislikes) and displaying advertisements to a subject based on characteristics of the subject's community. U.S. Pat. No. 5,848,396 to Gerace describes a method of generating psychographic profiles of end users by recording their computer activities and viewing habits, and targeting advertisements based on the user profiles. U.S. Pat. No. 5,636,346 to Saxe describes an advertisement targeting system that relates carrier subscriber data to other proprietary marketing databases by creating, compiling and updating a national directory of information derived from actual cable systems and telephone company billing records. Such user profiles are stored as a user database by a provider or carrier, or at the user end, and are used to target contents to the users.

Despite advances in the prior art, there still exists a need for more effective media targeting that is not reliant on a user profile or demographics.

### SUMMARY OF THE INVENTION

The present invention is directed to a system and method for preparing media objects for optimal targeting to their eventual users. The present invention provides a system and method for generating media object profiles associated with individual media objects, and using such media object profiles to target the media objects to users. One aspect of the present invention is a method of capturing user activity information representing the exercise of each media object by users, and filtering the captured user activity information to generate a profile associated with each media object. A media object profile is a profile of an individual media object, in a similar sense that a user profile is a profile of an individual user.

Another aspect of the present invention is a method of making “smart media objects” by generating a coded header attached to each media object representing a profile for that media object.

Yet another aspect of the present invention is a method for utilizing smart media objects having coded headers to target the media objects to users, by detaching and decoding the coded headers to obtain the media object profile and making targeting decisions based on the profile. Still another aspect of the invention is a smart media object, i.e., an information object having a content portion containing information to be used by end users and a profile portion containing coded profile information representing the exercise of the media object by users, where the content portion and the profile portion are assembled into an information object capable of being transmitted integrally.

In a preferred embodiment, the invention provides a system for targeting media content to at least one user. The system includes a data reporter for collecting user activity information representing the exercise of a first media object or profile by the one or more users, a coding system for correlating information gathered by the data reporter with the one or more first media objects, and a mediator for responding to a user interaction and providing to the user at least a second media object based upon the information correlated with at least the first media object or profile.

It is to be understood that both the foregoing general description and the following detailed description are exemplary and explanatory and are intended to provide further explanation of the invention as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 schematically illustrates an intelligent media targeting system including a user activity data reporting portion in accordance with the present invention.

FIG. 2 schematically illustrates an intelligent media targeting system for generating and utilizing smart media objects in accordance with the present invention.

FIG. 3 schematically illustrates a method of targeting media objects by utilizing smart media objects in accordance with the present invention.

### DETAILED DESCRIPTION OF THE DRAWINGS

Reference will now be made to preferred embodiments of the invention, examples of which are illustrated in the accompanying drawings. Wherever possible, the same reference numbers will be used throughout the drawings to refer to the same or like parts.

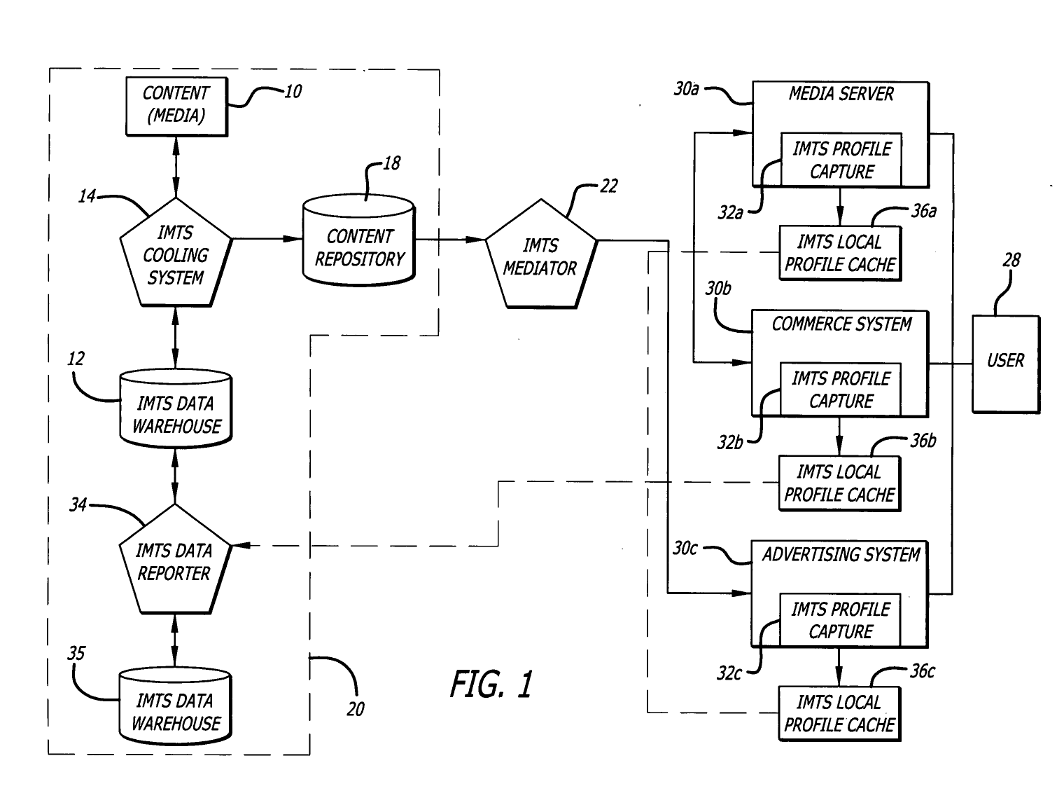

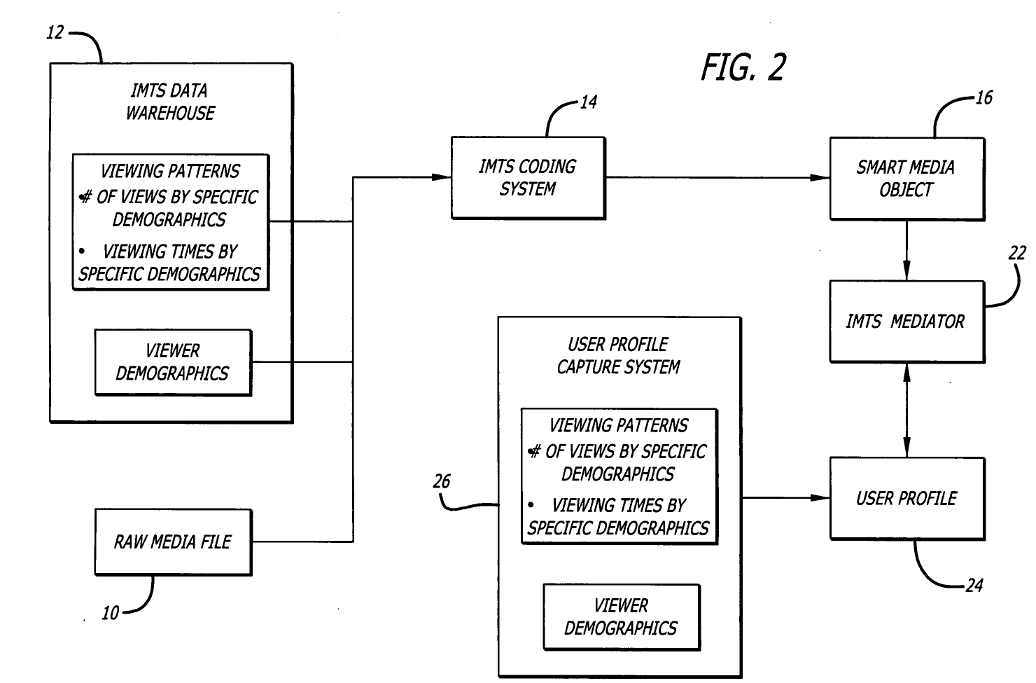

FIGS. 1 and 2 show an intelligent media targeting system (IMTS) and data flow within the system according to preferred embodiments of the present invention. Media contents or objects available within the system are stored in a raw media content file or database 10, while a profile database or warehouse 12 stores user activity and other information associated with the media contents. The media content may take the form of, for example, an audio-visual recording, sound recording, advertisement, Internet links, e-commerce asset (such as a JPEG image of a T-shirt for sale over a media system), or other digital content that may or may not be enhanced with targeting information. User activity information may include information indicating that a piece of media is exercised (e.g., purchases, viewed, interacted with) by a user, and is captured when the user exercises the media. The user activity information is derived at least partly from automatically captured user activity information. A coding system 14 filters the user activity information and the other information in the profile database to generate a coded header for each media object. Coding system 14 is preferably a software program or set of software systems for adding intelligent headers to media objects. A coded header is preferably an encoded descriptor (i.e., data) associated with a specific media object that includes targeting information unique to a media object. The filtering process may include, for example, analyzing the various “types” of information that exist, giving each type an appropriate priority weight and aggregating the sum into a unified code. The types of information include not only user behavior or activity associated with a media asset, but also historical information about similar assets that had previously existed in the archive or from another source. The resulting coded header has enough information where it can be later broken back into its components for optimum targeting. The coded header is then attached to the media object by the coding system to produce a “smart media object” 16 which is then stored in content repository or archive 18. Content repository 18 is preferably a central storage device for archiving the media objects.

In a preferred embodiment, smart media object 16 includes a media object portion, and a media object profile. More preferably, smart media object 16 is a media object that is associated with a coded header representing a profile of that media object, the profile being derived at least partially from captured user activity information and other information associated with the media object. A media object portion is the portion of the smart media object relating to the content (for example, a movie), as opposed to the header or profile portion of the smart media object. A media object profile includes the description term(s) for the characteristic of the data associated with the media object. The media object profile may preferably contain raw information such as information associated with the media object, as well as calculated or statistical information for use by other components of the system. Raw media content file or database 10, profile database 12, coding system 14, and content repository 18 are preferably located at a central location such as a back office 20 for example. Here, the term location is not limited to physical locations, and may mean servers and the like.

The information coded in the headers of smart media objects 16 is utilized by mediator 22, which may be a computer program, and may be located in a central office and/or local offices, to make targeting decisions to target the media objects to users. The mediator is preferably a software program or system capable of comparing two or more sets of independent data and performing specific logical tasks based on such a comparison. The mediator 22 detaches the header from smart media object 16 and decodes the header to obtain the media object profile. The media object profile contains enough information for optimal targeting by mediator 22. Targeting decisions may be based on, for example, the kind of products the user buys, the kind of television shows the user watches, or the user's actor preferences. The information contained in the media object profile may then be matched with user profiles stored in an optional user profile database 24 connected to the mediator 22. The user profiles, which represent demographic, psychographic and other information associated with individual users, may be generated by a user profiling system 26 generally known in the art. According to the targeting decisions made by the mediator 22, media objects are ultimately delivered to end users 28 through any one of a number of delivery systems, such as for example, media server 30a, commerce system 30b, or advertising system 30c.

The intelligent media targeting system also includes a user activity information capture and reporting system that reports information related to user activities (user activity information) back to the central location. Although the preferred embodiment uses a centralized location, it should be understood that such use is only preferred. For example, the invention may also make use of regional locations rather than a centralized location. Each media server 30a, commerce system 30b, advertising system 30c, in the local offices contains a user activity capture section 32a-c, respectively, that captures user activity information in real time. The captured user activity information may be sent back to a data reporter 34 located in the central office in real-time, such as by transmitting a code to the reporter when a media object is exercised by a user, and stored in administrative server 35 or profile or data warehouse 12. Data reporter 34 preferably is a repository of all user-related information that processes the data in a form that is useful to the overall data warehouse of information. It is also preferably a software implemented feedback mechanism for logging activity in a central location typically implemented through software. The data reporting can be done in real time, as assets are used, or in a store-and-forward method. In a real time example using cable television, one or more users watch an interactive show about the history of rock and roll. Each user, through his or her activity spends a great deal of time in a particular female rock artist section and as a result of several users doing the same thing, the history of rock and roll media asset now includes some targeting information that statistically values the particular female rock artist-related opportunities as high.

Alternatively, the captured user activity information may be stored in local profile caches 36a-c connected to the media server 30a, commerce system 30b, or advertising system 30c in filtered or unfiltered form, and forwarded to data reporter 34 at a later time. The user activity capture sections 32a-c may be a part of a user profiling system already incorporated in many media delivery systems.

In another embodiment, the IMTS may create smart media objects based solely on content usage. For example, a media object profile may be built having only certain statistical or affinity information. One such statistic could be, for example, the number of times a movie was ordered when an advertisement for it accompanied another movie.

Another example could involve web pages. When a web page use is detected or a request for a particular page made, links to other web pages or advertisements may be sent by the IMTS mediator with the requested page based on statistics, data or object profiles showing a high volume of requests made for a subsequent media object whenever it accompanies the first requested object. In essence, the headers accompanying the media object have a profile based only on content usage rather than the characteristics of any particular users. The IMTS mediator then chooses and directs the smart media objects based on continually or periodically updated object profiles. This embodiment may be made to be adaptable for use with those systems having personal user profile systems.

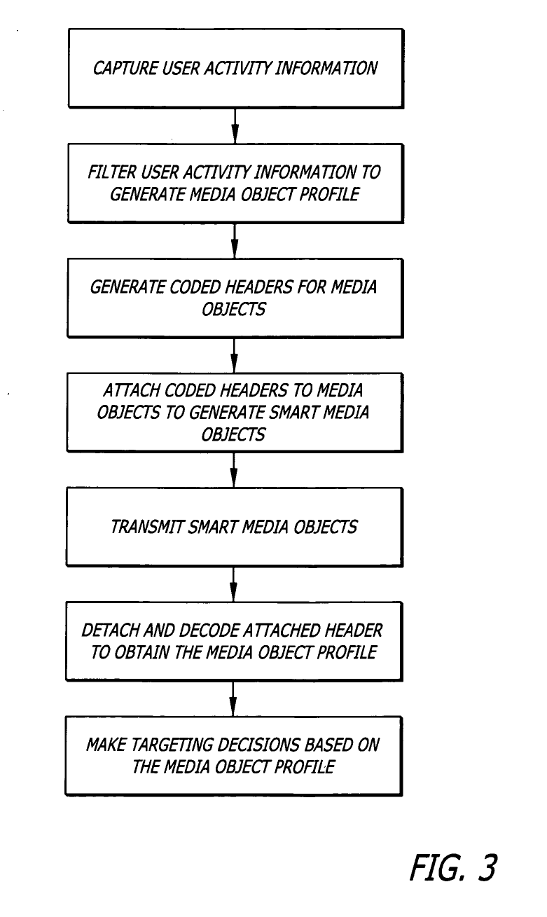

FIG. 3 illustrates a media targeting method according to a preferred embodiment of the present invention. The method includes the following steps: (a) capturing user activity information (historical information), e.g., information regarding exercise of media objects by users; (b) filtering the user activity information to generate a media object profile; (c) generating a coded header from the filtered user activity information and other pertinent information; (d) attaching the coded header to the media object to generate a smart media object; (e) transmitting the smart media object over a communication channel; (f) detaching and decoding the header from a received smart media object to obtain the media object profile information; and (g) making media targeting decisions utilizing the media object profile information.

The captured user activity information may be, for example, the event of viewing of a media object A by a user B. Such raw information is filtered to generate filtered user activity information or statistical information, for example, values representing the total number of viewings or total viewing time of the media object A by a demographic group C. The filtered user activity information may be updated as new user activity information is captured and reported, such as when a user belonging to the demographic group C views the media object A. In addition to information of user exercise of the particular media object, other information may also be included in a media object profile, such as data manually assigned to the media contents, e.g., genre; demographic information and behavior patterns of the users who have used that media object; cross-correlation between different particular media object and other media objects. For example, a profile for programming content may specify that this content has been viewed by people who have a particular demographic profile; purchase a particular type of product; or watch other programs that have an affinity relationship with the viewed piece of content. In this situation, user profile information from existing user profile databases may be incorporated into the media object profile.

The media targeting step is accomplished by matching the data fields included in the media object profile to a list of data fields associated with a user list, such as a list of subscribers of a particular service from a subscriber management system. For example, a service provider could target all the programming titles that have been primarily viewed by a particular demographic group to members of that demographic group. In another example, if the user profiling system keeps track of the programs viewed or purchased by a user, this information may be matched with available e-commerce opportunities to target e-commerce products directly to the user. In the latter example, the profile of a media object may be used to target other media objects than the one carrying the profile. This would allow a localized advertising system to target users who viewed a particular program with specific advertisements.

The filtering method used to generate media object profiles from user activity and other information typically implements profiling models and assumptions based on, for example, statistical, psychological, or business considerations; the assumption being that users having similar demography may have similar preferences. Similarly, the media targeting decisions typically implement targeting models and assumptions based on, for example, statistical, psychological, or business considerations. Any such profiling and targeting models and assumptions may be implemented in the present invention. Although the previous example involved the use of demographic user information or individual user characteristics, the present invention may work without such information.

When generating the coded header from the filtered user activity information, any suitable coding system may be used. In addition, the header may be attached to the media object in any suitable way, depending on the nature of the media object. For example, the coded header is preferably digital for digital contents, and analog for analog contents. The smart media objects may be transmitted from the central office to the local offices using any suitable broadcasting or communication channel. Further, any detaching and decoding system compatible with the coding and attaching system may be used to retrieve the profile information from the header.

The various steps described above need not be performed as separate steps. For example, filtering the user activity information and generating the coded header may be performed in one step, and generating and attaching the header to the media object may be performed in one step. Moreover, a variety of data processing and flow patterns may be employed, although some patterns may be more efficient than others. The processing steps may be performed at different locations within the system, and the data may flow between the locations in different forms as processed, partially processed or unprocessed data. For example, the user activity information that is captured in real time (as the user activity occurs) may be transmitted to the back office in the form of raw data. Alternatively, it may be stored in local caches and/or filtered (processed) by local servers to generate filtered data representing statistical information. The filtered data may then be transmitted at a later time to the back office, where information received from multiple local offices may be further filtered. As another example, the media object profile information may be stored in various forms. In one embodiment, the filtered user activity information is stored in a database at the back office and continuously updated. If the data reporting is updated in real time, the coded headers of the media objects become dynamic and real time accurate or near real time accurate as well. For example, the coded headers can be generated and attached to media objects in real time, i.e., when a media object is to be delivered to a local server or an end user. Alternatively, the coded headers may be generated and stored in a database at the back office, and continuously updated. The stored headers may be attached to media objects in real time. As another alternative, the coded headers may be generated and attached to the media objects, creating smart media objects which may be stored in content repository 18 (FIG. 2) at the back office. The smart media objects could then be updated in real time, or periodically updated.

In another embodiment, the present invention may also be used as a hidden search engine for Internet use. That is, one or more web links may be provided with a user requested web page, existing outside the confines of the web page itself. Such an embodiment would allow the invention to be used with traditionally non-commercial sites, for example, a movie fan club site. In such an example, IMTS would collect information from a plurality of users of a medium. A coding system would correlate the collected information with an archive of Internet links to create a profile for each link. Each link profile could contain, for example, information based on link usage with other links. As an illustration, a link profile of a link to a specific movie fan club may contain information about the number of times that link was exercised with in combination with a link to the “official” movie site, or in combination with a link to another site highlighting a particular movie star.

As the universe of Internet links is vast, the coding system may perform statistical calculations to archive a portion of all known Internet links, for example, the 10% most popular links.

When IMTS receives a request for a particular link, or user requested link, the mediator obtains the user requested link and selects at least one link having a profile matching one or more aspects or characteristics of the profile of the requested link. The mediator then delivers the user requested link together with the selected links.

In the movie illustration above, a user may request a particular movie link. The mediator would retrieve the requested link and provide the user with other links with the requested link. The user could then view the web page requested and be provided with hypertext links just outside the viewing frame of the web page leading to sites most visited by users who request the movie site. The movie site need not itself even have links to commercial sites. IMTS could provide targeted advertising to viewers of non-commercial sites, or sites that themselves have no link to the particular link provided by IMTS with the user requested link. For example, the movie site may not have links to a site advertising souvenirs, or no links to outside sites at all. IMTS would include such links even though the websites themselves have no link to the particular site, for example, the souvenir site.

In summary, by generating a profile for each media object from user activity user activity information and other information, the intelligent media targeting system according to the present invention enables effective targeting of media objects to end users. By attaching the media object profile to the media object as a header, transmitting media objects carrying their own profile (smart media objects), and subsequently detaching and decoding the header to retrieve the media object profile, the system allows the media object profiles to be generated at a central location, and utilized by local offices in a distributed manner. Such a system enables programming and service options to be uniquely made available to a user or a group of users to increase the personalization of the service and ultimately enhance the user's experience, and enables advertising and e-commerce opportunities to be optimized for revenue potential. Furthermore, the personalization of service may be accomplished without using individual user characteristics such as age, gender, or location.

It will be apparent to those skilled in the art that various modifications and variations can be made in the media targeting system of the present invention without departing from the spirit or scope of the inventions. Thus, it is intended that the present invention cover modifications and variations of this invention that come within the scope of the appended claims and their equivalents.

What is claimed is:

1. A system for targeting media content to a plurality of users, comprising:
a first media object comprising at least one of an audio-visual recording, a video recording, a sound recording, an Internet link, an advertisement, and an e-commerce asset;
a data reporter for gathering content use information generated by user interaction with said first media object by said users, the content use information not being correlated with any attribute of said users;
a coding system utilizing the content use information gathered by said data reporter not correlated with any attribute of said users, said coding system correlating the content use information with at least said first media object to create a media object profile, said media object profile being attached to said first media object, said media object profile not including any attribute of said users; and
a mediator for detaching said media object profile from said first media object and providing to at least one of said users at least a second media object based on said media object profile detached from said first media object.

2. The targeting system of claim 1, wherein said coding system creates at least one smart media object, said at least one smart media object having a media object portion and said media object profile.

3. The targeting system of claim 2, further comprising a content repository for storing said at least one smart media object until said mediator requests said at least one smart media object.

4. The targeting system of claim 2, wherein each of said media object profiles contains information pertaining to a related one of said media object portions calculated from the content use information.

5. The targeting system of claim 1, wherein said coding system correlates the content use information in real time.

6. The targeting system of claim 1, wherein said coding system periodically updates the content use information correlated with said at least one media object.

7. A system for targeting media to a plurality of users, comprising:
a user requested media object comprising at least one of an audio-visual recording, a video recording, a sound recording, an Internet link, an advertisement, and an e-commerce asset;
a data reporter for gathering content use information generated by user interaction with said user requested media object by said users, the content use information not being correlated with any attribute of said users;
a media object archive for storing media objects;
a coding system for assigning the content use information not correlated with any attribute of said users from said data reporter to at least one of said stored media objects to create a media object profile for at least one of said stored media objects and said user requested media objects, said media object profile being attached to said at least one of said stored media objects and user requested media objects, said media object profile not including any attribute of said users; and
a mediator for detaching said media object profile from said at least one of said user requested media objects and selecting at least one of said stored media objects having a media object profile matching at least one characteristic of said media object profile detached from said at least one of said user requested media objects.

8. The targeting system of claim 7, wherein said coding system creates at least one smart media object, said at least one smart media object having a media object portion and said media object profile.

9. The targeting system of claim 8, further comprising a content repository for storing said at least one smart media object until said mediator requests said at least one smart media object.

10. The targeting system of claim 8, wherein each of said media object profiles contains information pertaining to a related one of said media objects calculated from the content use information.

11. The targeting system of claim 7, wherein said coding system correlates the content use information in real time.

12. The targeting system of claim 7, wherein said coding system periodically updates the content use information correlated with said at least one media object.

13. A method for targeting at least one media object to a plurality of users, comprising:
identifying a user requested media object comprising at least one of an audio-visual recording, a video recording, a sound recording, an Internet link, an advertisement, and an e-commerce asset;
gathering content use information generated by user interaction with said user requested media object by said users without correlating the content use information with any attribute of said users;
assigning the content use information not correlated with any attribute of said users to at least said user requested media object, each media object having a content portion;
generating a coded header including a media object profile for said user requested media object and attaching said coded header to said user requested media object, said media object profile not including any attribute of said users;
detaching said coded header from said user requested media object and decoding said coded header to retrieve said media object profile;
matching at least one characteristic of said media object profile of said user requested media object retrieved from said detached coded header with said media object profile of at least a second media object; and
delivering said user requested media object with at least said second media object having a media object profile matching at least one characteristic of said media object profile of said user requested media object retrieved from said detached coded header.

14. The method of claim 13, wherein the assigning the content use information is performed in real time.

15. The method of claim 13, wherein the assigning the content use information is performed periodically.

16. A method of targeting media objects to a plurality of users, comprising:
collecting content use information from user interaction with user requested Internet links without correlating the content use information with any attribute of said users;
correlating the collected information not correlated with any attribute of said users with at least one of said user requested Internet links;
creating at least one Internet link profile based on the correlated content use information and attaching said created Internet link profile to said at least one of said user requested Internet links, said at least one Internet link profile not including any attribute of said users; and
selecting at least a second Internet link based on the created Internet link profile of the user requested Internet link and delivering to the user the user requested link and at least the second Internet link having a link profile matching at least one aspect of the profile of the user requested link.

17. The method of claim 16, wherein at least one of said Internet links leads to a web site.

18. The method of claim 16, wherein at least one of said Internet links leads to a non-commercial web page.
